(19) United States
(12) Patent Application Publication
(10) Pub. No.: US 2001/0045678 A1
(43) Pub. Date: Nov. 29, 2001

(54) Three-dimensional modeling apparatus

(75) Inventors: Naoki Kubo, Nishinomiya-Shi (JP); Shigeaki Tochimoto, Osaka (JP)

Correspondence Address: MCDERMOTT WILL & EMERY, 600 13th Street, N.W., Washington, DC, 20005, US

(73) Assignee: Minolta Co., Ltd.

(21) Appl. No.: 09/860,610

(22) Filed: May 21, 2001

(30) Foreign Application Priority Data
May 25, 2000 (JP) P2000-155041

(51) Int. Cl. B29C 41/08

(52) U.S. Cl. 264/37.29; 264/308; 264/236; 425/375; 425/445; 425/215

(57) ABSTRACT

To replenish a powder supply section (40) with a powder material, a powder-material reservoir (30) is mounted in a reservoir placement section (43) located on the upper side of the powder supply section (40). After the completion of a modeling operation on a modeling stage (62) in a modeling mechanism (60), the modeling stage (62) is lowered and a carrier mechanism (65) operates to carry a mesh tray (9) and a three-dimensional (3D) object (91) on the modeling stage (62) to a treatment chamber (72). In the treatment chamber (72), removal of unbound powder adhering to the 3D object (91) and post-processing are performed automatically. Such a configuration allows automatic fabrication of a 3D object of high binding strength without scattering the powder material therearound.

This application is based on application No. 2000-155041 filed in Japan, the contents of which are hereby incorporated by reference.

### BACKGROUND OF THE INVETION

1. Field of the Invention

The present invention relates to a three-dimensional (3D) modeling technique especially for fabricating a 3D object by applying a binding material to bind powder.

2. Description of the Background Art

Conventionally known 3D modeling apparatuses fabricate a 3D object by repeating layer formation and binder application, the layer formation being to spread a powder material in a thin layer over a predetermined stage and the binder application being to apply a binder to predetermined parts of the layer to form a body of bound powder.

However to replenish such conventional 3D modeling apparatuses with a powder material to be a material for modeling, users themselves need to carry out the task of putting the powder material in a bag or the like into a powder tank in the 3D modeling apparatuses.

Further, for a final 3D object, the conventional 3D modeling apparatuses require the users to carry out the task of removing a powder material that has received no binder during the modeling process, from the generated 3D object.

A 3D object fabricated by the conventional 3D modeling apparatuses is merely a powder material bound with predetermined binders and thus has a brittle surface. Thus, after taking out such a 3D object, the users need to provide manual post-processing on the 3D object to increase the binding strength.

Any of the aforementioned users' tasks requires not only time and manpower but also incurs the possibility of dirtying users' hands, clothes, or the like. There is a problem, too, that during the tasks, the powder material may be scattered to the outside around the apparatuses.

### SUMMARY OF THE INVENTION

The present invention is directed to a three-dimensional modeling apparatus for fabricating a three-dimensional object by binding a powder material with a binding material.

According to an aspect of the present invention, this apparatus comprises: a modeling section for forming a body of bound powder material in sequence by applying the binding material to the powder material to bind the powder material, thereby to generate the three-dimensional object; a placement section for mounting of a powder material reservoir containing the powder material; and a powder supply section for supplying the powder material in the powder material reservoir mounted in the placement section to the modeling section.

The apparatus can thus replenish the powder supply section with the powder material only by mounting a powder material reservoir in the placement section, which avoids dirtying users' hands, clothes, or the like. Also, such powder-material replenishment can be accomplished without scattering the powder material around the apparatus.

According to another aspect of the present invention, this apparatus comprises: a supply section for supplying the powder material; a modeling section for forming a body of bound powder material in sequence by selectively applying the binding material to the powder material supplied from the supply section to bind the powder material, thereby to generate the three-dimensional object; and a removal section for removing an unbound powder material from the three-dimensional object generated in the modeling section, the unbound powder material being the powder material supplied from the supply section but not receiving the binding material.

This avoids the necessity of users carrying out the task of removing the unbound powder material. Also, removal of the unbound powder material can be accomplished without scattering the powder material around the apparatus.

According to still another aspect of the present invention, this apparatus comprises: a supply section for supplying the powder material; a modeling section for repeating a process of applying the binding material to the powder material supplied from the supply section to bind the powder material in order to represent each section of the three-dimensional object, thereby to generate the three-dimensional object; and a feed section for recovering and returning an unbound powder material to the supply section, the unbound powder material being the powder material supplied from the supply section but not receiving the binding material.

This allows for reuse of the unbound powder material.

The present invention is also directed to a three-dimensional modeling method for fabricating a three-dimensional object by binding a powder material with a binding material. The method utilizes a predetermined apparatus to avoid users' contact with the powder material.

According to an aspect of the present invention, this method comprises the steps of: (a) placing a mesh tray for use in passing the powder material into the bottom of a box-like modeling space, in such a manner as to support a whole bottom surface of the mesh tray; (b) repeating a process of supplying the powder material flatly in a predetermined thickness in the modeling space and a process of selectively applying the binding material onto the powder material supplied to bind the powder material in order to represent a predetermined shape, thereby to generate on the mesh tray the three-dimensional object bound with the binding material with an unbound powder material remaining therewith; (c) supporting part of the mesh tray above a predetermined space for collecting the unbound powder material; and (d) dropping the unbound powder material into the predetermined space to obtain the three-dimensional object.

The method can thus fabricate a three-dimensional object without scattering the powder material therearound.

As above described, the present invention is made in view of the conventional problems and thus resolving such conventional problems is the first object of the present invention. The second object is to provide a three-dimensional modeling apparatus that can automatically fabricate a three-dimensional object of high binding strength without scattering a powder material therearound. The third object is to provide a three-dimensional modeling apparatus that provides users with ease of use. The fourth object is to fabricate a three-dimensional object without dirtying users' hands, clothes, or the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a 3D modeling apparatus according to a first preferred embodiment;

FIGS. 2A to 2C show the lid of a powder material reservoir;

FIGS. 3A to 3C show how to locate the powder material reservoir in a tank;

FIG. 4 is a flow chart showing the operating procedure of the 3D modeling apparatus according to the first preferred embodiment;

FIGS. 5A to 5C, 6A to 6C, 7A to 7C, and 8 are schematic diagrams illustrating operations of the 3D modeling apparatus according to the first preferred embodiment;

FIG. 9 is a schematic diagram of a 3D modeling apparatus according to a second preferred embodiment;

FIG. 10 is a schematic diagram showing the operating procedure of the 3D modeling apparatus according to the second preferred embodiment;

FIGS. 11A to 11C, 12A to 12C, 13A to 13C, and 14A, 14B are schematic diagrams illustrating operations of the 3D modeling apparatus according to the second preferred embodiment;

FIG. 15 is a schematic diagram of a 3D modeling apparatus according to a third preferred embodiment.

### DESCRIPTION OF THE PREFERRED EMBODIMENTS

Hereinbelow, preferred embodiments of the present invention will be set forth in detail with reference to the drawings.

<1. First Preferred Embodiment>

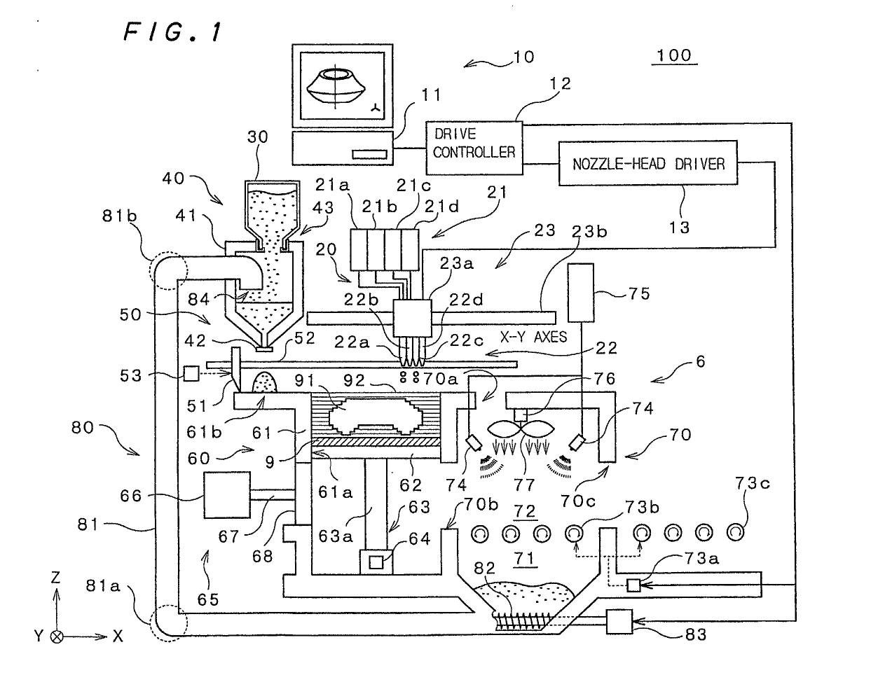

FIG. 1 is a schematic diagram of a three-dimensional (3D) modeling apparatus 100 according to a first preferred embodiment of the present invention. This apparatus 100 applies a binding material to a predetermined powder material to bind the powder material for forming a body of bound powder material in sequence, thereby to fabricate a 3D object as a final body of bound powder.

The 3D modeling apparatus 100 comprises a control section 10, a binder supply section 20, a modeling section 6, a powder supply section 40, a powder spreading section 50, and a powder recovery mechanism (feed section) 80, wherein there is an electrical connection between the control section 10 and each of the other sections. The modeling section 6 is integrally formed with a modeling mechanism 60 and a powder removal section 70.

The control section 10 comprises a computer 11, a drive controller 12 having an electrical connection to the computer 11, and a nozzle-head driver 13 having an electrical connection to the drive controller 12.

The computer 11 is for example a general desktop computer comprising a CPU, a memory, and the like. The computer 11 converts an object of three-dimensional shape into shape data and slices the shape data into a plurality of parallel sections to obtain section data for each section which is then outputted to the drive controller 12.

The drive controller 12 serves as a controller for controlling the operation of each section according to the section data from the computer 11. Upon receipt of the section data from the computer 11, the drive controller 12 gives a drive command based on the section data to each of the above sections for centralized control of the operation of the modeling mechanism 60 in the modeling section 6 for formation of successive layers of a body of bound powder material. After the completion of the modeling, the drive controller 12 causes the powder removal section 70 in the modeling section 6 to remove unbound powder, while exercising control over each operation for post-processing of the generated 3D object.

The binder supply section 20 comprises a tank section 21 for liquid binders which are binding materials for use in binding of the powder material, a nozzle head 22 for ejection of the binders in the tank section 21, and an XY-directional driver 23 for moving the nozzle head 22 in a horizontal XY plane.

The tank section 21 includes a plurality of tanks (in this example, four tanks) 21a to 21d each containing a binder of different color. More specifically, the tanks 21a to 21d contain binders of three primary colors: yellow (Y), magenta (M), and cyan (C), and a binder of white (W), respectively. Preferably, such colored binders are not discolored on binding with powder and are neither discolored nor faded with time.

The nozzle head 22 is fixed to a lower part of the XY-directional driver 23 to be movable in the XY plane integral with the XY-directional driver 23. The nozzle head 22 comprises the same number of ejection nozzles 22a to 22d as the number of tanks in the tank section 21, the ejection nozzles 22a to 22d being individually coupled to the tanks 21a to 21d, respectively, by four tubes. Each of the ejection nozzles 22a to 22d is a nozzle for ejecting (jetting) droplets of each binder using an ink jet technique, for example. The binder ejection from the ejection nozzles 22a to 22d is individually controlled by the nozzle-head driver 13 and the binders from the ejection nozzles 22a to 22d will adhere to a powder layer 92 in the modeling mechanism 60 which is located opposite the nozzle head 22.

The XY-directional driver 23 comprises a main body 23a and a guide rail 23b. The main body 23a is reciprocally movable in the X direction along the guide rail 23b and is also movable reciprocally in the Y direction. By the action of the XY-directional driver 23, the nozzle head 22 can move in a plane defined by the X and Y axes. That is, the XY-directional driver 23 can move the nozzle head 22 to any desired position within its operating range in the above plane at a drive command from the nozzle-head driver 13. According to the position of the nozzle head 22 in the XY plane, the nozzle-head driver 13 selectively controls the binder ejection from the plurality of ejection nozzles 22a to 22d so that the binders are applied to necessary parts of the powder layer 92 in the modeling mechanism 60.

The modeling mechanism 60 comprises a main body 61 having a hollow portion, a modeling stage 62 forming a bottom surface of the hollow portion of the main body 61, a Z-directional moving section 63 for moving the modeling stage 62 in the Z direction, and a driver 64 for driving the Z-directional moving section 63.

The main body 61 of the modeling mechanism 60 performs a function of providing a work area for fabricating a 3D object 91 from the powder material. On one end side of the upper part, the main body 61 has a temporary depot 61b for temporary storage of the powder material supplied from the powder supply section 40.

The modeling stage 62 is rectangular in XY cross section, having its side faces in contact with a vertical interior wall 61a of the hollow portion of the main body 61. A mesh tray 9 is placed on the modeling stage 62. A three-dimensional space of a rectangular parallelepiped (i.e., space in the hollow portion) formed by the modeling stage 62 and the vertical interior wall 61a of the main body 61 serves as a modeling space for fabrication of a 3D object 91. Then, successive thin layers of powder material are formed on the mesh tray 9 on the modeling stage 62 while after formation of each layer, necessary parts of the powder material are bound with the binders ejected from the ejection nozzles 22a to 22d on the modeling stage 62. This results in the fabrication of the 3D object 91.

The Z-directional moving section 63 has a bearing bar 63a coupled to the modeling stage 62. Vertical reciprocating movement of the bearing bar 63a by the driver 64 effects Z-directional movement of the modeling stage 62 coupled to the bearing bar 63a.

On the side wall of the main body 61 of the modeling mechanism 60, a carrier mechanism 65 is provided to carry the 3D object 91 generated in the modeling mechanism 60 into the powder removal section 70. The carrier mechanism 65 comprises a carrier driver 66, an extension member 67, and an extruding member 68.

The carrier driver 66 is constituted by a cylinder or the like and a drive thereto is controlled by the drive controller 12. The extension member 67 is driven by the carrier driver 66 to extend and contract horizontally (in the X direction). The extruding member 68 is coupled to the tip of the extension member 67 and cooperates with extension and contraction of the extension member 67 to move horizontally (in the X direction).

After the 3D object 91 is generated as a body of bound powder material on the modeling stage 62, the modeling stage 62 descends to a predetermined position. This predetermined position is a position at which the extruding member 68 can extrude the mesh tray 9 sideways (in the X direction).

The carrier mechanism 65 is configured to extrude and carry the mesh tray 9 and the 3D object 91 sideways (in the X direction) to the powder removal section 70 which is located next to the modeling mechanism 60, after the descent of the modeling stage 62. More specifically, the 3D object 91 is carried to the powder removal section 70, passing through an opening 70b provided between the modeling mechanism 60 and the powder removal section 70.

The powder removal section 70 is provided with a plurality of carrier rollers 73b for conveyance of the mesh tray 9 transmitted from the carrier mechanism 65. The carrier rollers 73b also have a function of supporting the mesh tray 9 received from the carrier mechanism 65 at a position near the center of a treatment chamber 72. The carrier rollers 73b are reversibly rotatable by a driver 73a. The driver 73a is constituted by a motor or the like and is controlled by the drive controller 12.

An air blower 77 is provided on the upper side of the treatment chamber 72 in the powder removal section 70. The air blower 77 is rotatably driven by a motor 76 to send air downwardly. Further, a recovery section 71 for powder material is provided under the carrier rollers 73b.

To remove unbound powder not receiving binders from the 3D object near the center of the treatment chamber 72, in the powder removal section 70, the carrier rollers 73b make reciprocating rotary motions at any angle within the prescribed range with the mesh tray 9 placed thereon. Such reciprocating motions give vibrations to the mesh tray 9 and the 3D object 91 on the rollers 73b along the X direction, thereby shaking off unbound powder adhering to the surface of the 3D object 91. The powder material, which has been shaken off, falls through the meshes of the mesh tray 9 and a clearance between each of the carrier rollers 73b, and is then deposited in the recovery section 71. In shaking off the unbound powder material with the above vibrations of the carrier rollers 73b, the air blower 77 in the upper part of the treatment chamber 72 operates to blow off unbound powder that adheres to areas where powder is difficult to remove by vibrations, in the downward direction by the force of the wind.

In this fashion, the powder removal section 70 can adequately remove the unbound powder from the 3D object 91 by the vibrations of the carrier rollers 73b and by the action of the air blower 77. That is, the carrier rollers 73b and the air blower 77 serve as an remover for unbound powder material. Such a powder removal section 70 allows the 3D modeling apparatus 100 to perform automatic removal of unbound powder as part of the sequential operation. Thus, users themselves need not to remove unbound powder after generation of the 3D object 91 and thus will not dirty their hands or clothes.

In this preferred embodiment, the powder removal section 70 also serves as a post-processing section. The post-processing includes, for example, a process of improving the binding strength (curing strength) of the 3D object 91 formed of the powder material bound for example with binders and a process of forming a protective film or the like on the surface of the 3D object 91. In this preferred embodiment, a spray nozzle 74 for spraying a curing material such as resin is provided on the upper side of the treatment chamber 72. On the upper side of the powder removal section 70, a replaceable curing material reservoir 75 for a liquid curing material is provided, from which a curing material is supplied to the spray nozzle 74.

For post-processing of the 3D object 91 in the treatment chamber 72 after the unbound powder is removed, the spray nozzle 74 in the powder removal section 70 sprays a curing material. The 3D object 91 on the carrier rollers 73b is impregnated with the curing material from the spray nozzle 74. After a predetermined period of time has elapsed from the start of the spray from the spray nozzle 74, the 3D object 91 is impregnated with a proper amount of curing material. Then, the air blower 77 is actuated to dry the curing material on the 3D object 91, which results in the improvement in the binding strength of the 3D object 91. From this, the spray nozzle 74 and the air blower 77 serve as a post-processor for post-processing of the 3D object 91.

At the completion of the aforementioned post-processing, an operation to carry the 3D object 91 is performed. An opening 70c is provided on the wall side opposite from the opening 70b of the powder removal section 70 and a plurality of carrier rollers 73c are provided outside the opening 70c. Like the carrier rollers 73b, the carrier rollers 73c are driven by the driver 73a. At the completion of the post-processing, the driver 73a rotatably drives the carrier rollers 73b and 73c in a predetermined direction so that the mesh tray 9 and the 3D object 91 are carried onto the carrier rollers 73c along the X direction. When the mesh tray 9 is carried onto the carrier rollers 73c, users can obtain the post-processed 3D object 91.

The powder removal section 70 also has an opening 70a at a predetermined position in the ceiling of the treatment chamber 72. The opening 70a is for leading an excess powder material to the recovery section 71 when a blade 51 in the powder spreading section 50 spreads the powder material over the modeling stage 62 for formation of each single powder layer 92. That is, in formation of a single powder layer 92 on the modeling stage 62, the blade 51 is moved at least over the opening 70a in the X direction, whereby an excess powder material falls through the opening 70a and is then deposited in the recovery section 71, passing through the treatment chamber 72 in the powder removal section 70.

A powder carrier screw 82 is provided at the bottom of the recovery section 71. The powder carrier screw 82 constitutes part of the powder recovery mechanism 80 for conveyance of a recovered powder material to the powder supply section 40.

Besides the powder carrier screw 82, the powder recovery mechanism 80 comprises a powder carrier conduit 81 and a driver 83. The powder carrier conduit 81 runs from the bottom of the recovery section 71 to the inside of a tank 41 in the powder supply section 40. Inside the powder carrier conduit 81, the powder carrier screw 82 made of a pliant material runs from the bottom of the recovery section 71 to around a conduit end 84 inside the tank 41. Although the powder carrier conduit 81 has two bends 81a and 81b therein as shown in FIG. 1, the powder carrier screw 82 made of a pliant material can be bent at those bends 81a and 82b along the powder carrier conduit 81. Preferably, the bends 81a and 81b each have a large bend radius so that the screw torque will effectively be transmitted before and behind those bends.

One end of the powder carrier screw 82 is coupled to a rotation axis of the driver 83 constituted by a motor or the like and upon rotation of the driver 83 in a predetermined direction, the powder carrier screw 82 also rotates in a predetermined direction about its center axis. This torque is effectively transmitted to the powder carrier screw 82 even at the bends 81a and 81b and thus the powder carrier screw 82 in the powder carrier conduit 81 totally cooperates with the driver 83 to rotate about its center axis.

Consequently, the powder material deposited in the recovery section 71 is carried through the powder carrier conduit 81 by the powder carrier screw 82 and resupplied to the inside of the tank 41 in the powder supply section 40 for reuse.

The powder supply section 40 comprises the tank 41 for powder material, and a shutoff plate 42 which is provided at a powder supply port (outlet) of the tank 41 to open and close the powder supply port at a command from the drive controller 12.

The tank 41 contains for example a white powder material. This powder material is for use in the formation of the 3D object 91, including for example starch and resin powder.

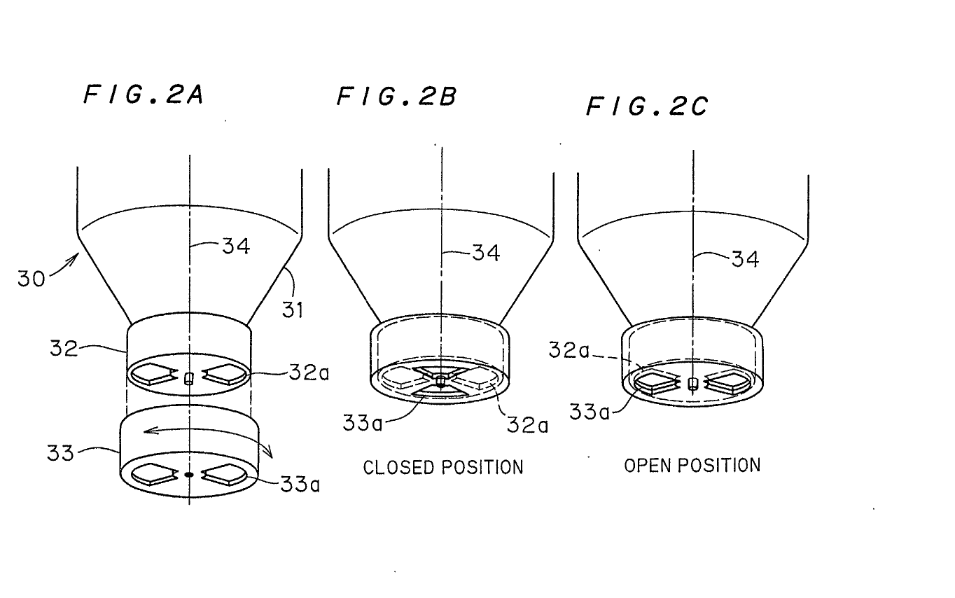

On the upper side of the tank 41, there is provided a reservoir placement section 43 for mounting a replaceable powder material reservoir 30. FIGS. 2A to 2C show the lid of the powder material reservoir 30. As shown in FIG. 2A, the lid of the powder material reservoir 30 has a double-lid structure of an inner lid 32 and an outer lid 33.

The inner lid 32 has two sector-form openings 32a for leading the inside powder material to the outside, the openings being symmetrically located with respect to a center line 34 of the powder material reservoir 30. Each sector of the openings 32a has a central angle of 90 degrees or less, for example. The inner lid 32 is fixed to a main body 31 of the reservoir 30.

The outer lid 33 also has two sector-form openings 33a for leading the powder material to the outside, the openings being symmetrically located with respect to the center line 34 of the powder material reservoir 30. Each sector of the openings 33a also has a central angle of 90 degrees or less, for example. The outer lid 33 is mounted over the inner lid 32 to be rotatable about the center line 34.

In a state prior to the mounting of the powder material reservoir 30 in the tank 41, the openings 32a of the inner lid 32 and the openings 33a of the outer lid 33 are located at 90 degrees to each other as shown in FIG. 2B. Thus, the outer lid 33 blocks the openings 32a of the inner lid 32 and there is no leakage of the inside powder material to the outside whatever the position of the powder material reservoir 30.

In a state after the mounting of the powder material reservoir 30 in the tank 41, on the other hand, the openings 32a of the inner lid 32 coincides with the openings 33a of the outer lid 33 as shown in FIG. 2C and thus the inside powder material is led to the outside through the openings 32a and 33a.

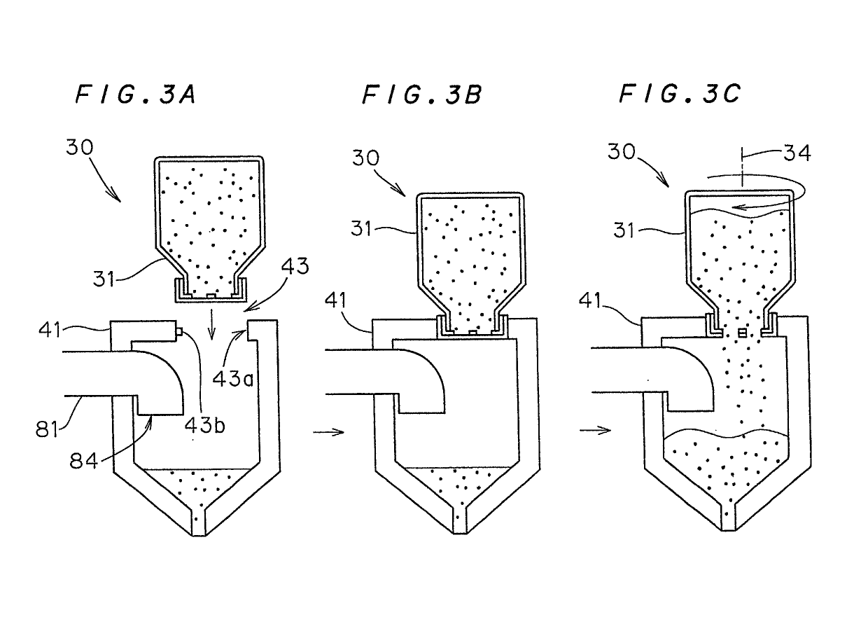

Now, the effect of placing the powder material reservoir 30 in the tank 41 and replenishing the tank 41 with the powder material will be described in further detail. FIGS. 3A to 3C show how the powder material reservoir 30 is placed in the tank 41.

As shown in FIG. 3A, the reservoir placement section 43 on the upper side of the tank 41 is formed of an opening 43a for insertion of the lid of the powder material reservoir 30 and a projection 43b provided in part of the opening 43a. The outer lid 33 of the powder material reservoir 30 has in the side surface a recess (not shown) for engagement with the projection 43b. In placement of the powder material reservoir 30 in the reservoir placement section 43, the projection 43b and the recess of the outer lid 33 are in engagement with each other. Consequently, the powder material reservoir 30 is placed on the upper side of the tank 41 as shown in FIG. 3B.

In a state shown in FIG. 3B, the openings of the inner and outer lids 32, 33 of the powder material reservoir 30 do not coincide with each other and thus there is no supply of the powder material in the reservoir to the tank 41. In the state of FIG. 3B, therefore, the main body 31 of the reservoir is rotated approximately 90 degrees about the center line 34 for example by a rotator for the reservoir's main body not shown or by a users' manual operation. At this time, since the recess of the outer lid 33 is in engagement with the projection 43b, the outer lid 33 does not make an angular movement and only the main body 31 and the inner lid 32 of the reservoir 30 move angularly about the center line 34. Consequently, as shown in FIG. 3C, the openings 32a of the inner lid 32 are brought in coincidence with the openings 33a of the outer lid 33 and the lid of the powder material reservoir 30 is brought to the open position. Then, the powder material in the powder material reservoir 30 falls under its own weight and is supplied through the openings 32a and 33a into the tank 41, whereby the tank 41 is replenished with the powder material.

By providing the reservoir placement section 43 for placement of the replaceable powder material reservoir 30 on the upper side of the tank 41, the tank 41 can be replenished with the powder material which falls under its own weight from the powder material reservoir 30 mounted in the reservoir placement section 43. Further, the projection 43b of the reservoir placement section 43 as an opener for the lid of the powder material reservoir 30 prevents scattering of the powder material in the powder material reservoir 30 to the outside of the tank 41. That is, by providing the projection 43b, the lid can be opened while leaving the powder material reservoir 30 mounted in the tank 41 and therefore the tank 41 can be replenished with the powder material without scattering of the powder material therearound.

While in the above description the lid of the powder material reservoir 30 has a double-lid structure of the inner lid 32 and the outer lid 33, this preferred embodiment is not limited thereto. For example, such a reservoir may have an opening covered with aluminum foil. In this case, if the reservoir placement section 43 has, as an opener, a mechanism for tearing the aluminum foil or the like simultaneously with the mounting of the powder material reservoir 30, replenishment of the tank 41 with the powder material can be accomplished without scattering the powder material around the apparatus.

Referring back to FIG. 1, the shutoff plate 42 is slidable horizontally (in the X direction) at a drive command from the drive controller 12. It starts and stops a supply of powder in the tank 41 to the temporary depot 61b in the modeling mechanism 60.

The powder spreading section 50 comprises the blade 51, a guide rail 52 for regulation of movements of the blade 51, and a driver 53 for moving the blade 51.

The blade 51 is long in the Y direction and has a sharp-pointed and sharp-edged lower tip. The length of the blade 51 along the Y direction is long enough to cover the width along the Y direction in 3D space. To smooth the spreading (diffusion) of the powder material by the blade 51, a vibration mechanism for transmitting slight vibrations to the blade 51 may additionally be provided.

The driver 53 allows vertical (Z-directional) and horizontal (X-directional) reciprocating movements of the blade 51. At a command from the drive controller 12, the driver 53 operates to move the blade 51 in the X and Y directions.

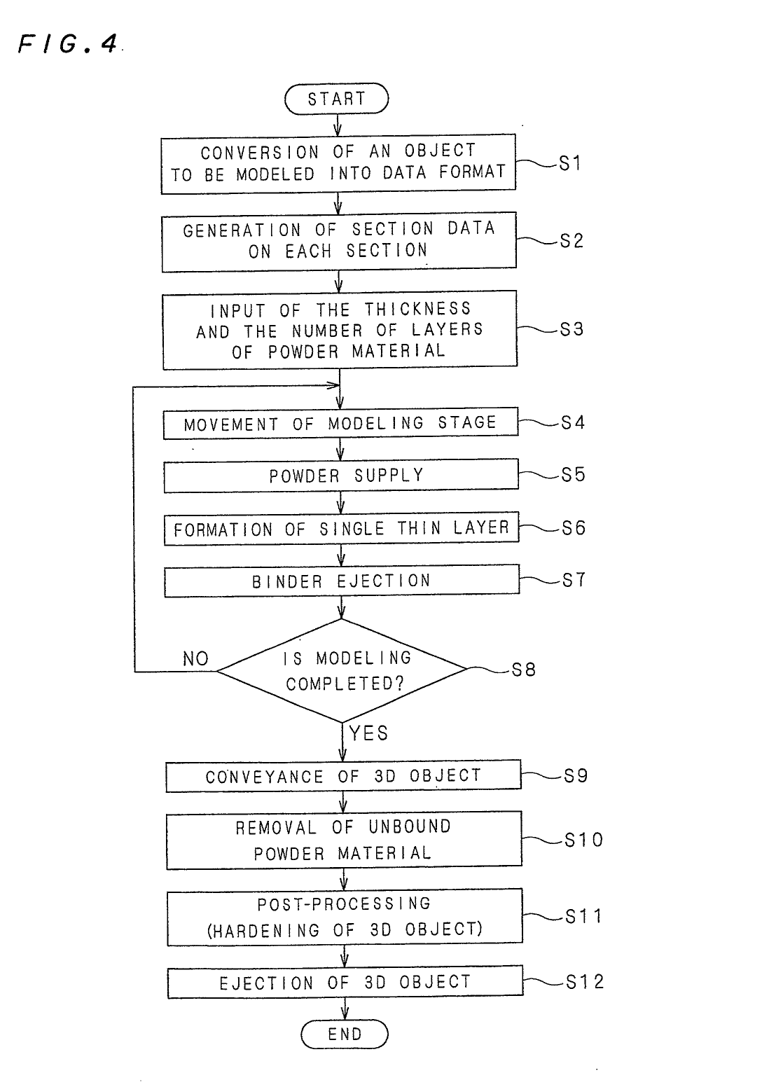

Next, actual operations of the 3D modeling apparatus 100 of the aforementioned configuration for fabrication of a 3D object will be set forth. FIG. 4 is a flow chart showing the operating procedure of the 3D modeling apparatus 100. Referring now to the drawing, the basic operation thereof will be described hereinbelow.

In step S1, the computer 11 generates model data which represents an object to be modeled with a color pattern or the like on the surface. As shape data to be the basis for modeling, for example, 3D color model data generated by common 3D CAD modeling software can be used. It is also possible to use shape data and texture obtained by measurement by a 3D shape input device.

The model data includes two types: those which contain color information about only the surface of a 3D object; and those which contain color information about the interior of a 3D object as well as color information about the surface thereof. In modeling using the latter, only the color information about the 3D object's surface can be used or the color information about both the 3D object's surface and interior can be used. In fabrication of a 3D object such as a human model, for example, it may be required to color the internal organs in different colors, in which case the color information about the 3D object's interior is used.

In step S2, the computer 11 generates section data on each horizontal section of the object to be modeled from the model data. More specifically, from the model data, a horizontal section is sliced off at a pitch corresponding to the thickness of a single layer in laminations of powder, thereby to generate section data on each horizontal section including shape and color data. A slice pitch can be changed within the prescribed range (the range of powder thickness that can be bound).

In step S3, information about the thickness of the powder layer (slice pitch in the generation of section data) and the number of powder layers (the number of section data sets) for modeling of an 3D object is transmitted from the computer 11 to the drive controller 12.

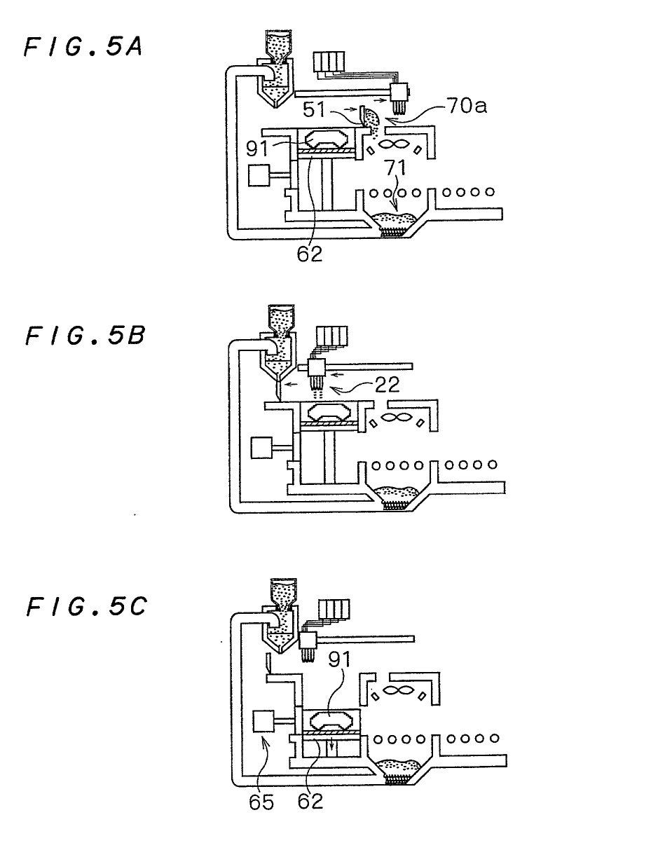

Subsequent steps S4 and later are operations performed under the control of the drive controller 12. FIGS. 5A to 5C, 6A to 6C, 7A to 7C, and 8 are schematic diagrams illustrating those operations.

In step S4, for formation of an N-th layer (N=1, 2, . . . ) of a body of bound powder on the modeling stage 62, the modeling stage 62 is lowered by the Z-directional moving section 63 by an amount corresponding to the layer thickness given by the computer 11 and is held in that position. Thereby, space to form a new single layer of powder is provided on the bound powder layer which was formed on the modeling stage 62 after necessary binder application.

In step S5, powder is supplied as a material for modeling of a 3D object. More specifically, the shutoff plate 42 in the powder supply section 40 slides from its closed position to a position where it drops a predetermined amount of powder material held in the tank 41 onto the temporary depot 61b in the modeling mechanism 60. The predetermined amount is set to be slightly larger than the volume of the above space (the necessary amount of powder for modeling). In formation of an initial layer (N=1), the predetermined amount should preferably be increased slightly more than the amount required for formation of the other layers (N>1), in consideration of the fact that the meshes of the mesh tray 9 will be filled with the powder material. After the supply of a predetermined amount of powder material is completed, the shutoff plate 42 returns to the closed position to stop the powder supply.

In step S6, the powder material supplied in step S5 is spread over the modeling stage 62 to form a single thin layer of powder material. More specifically, as shown in FIG. 5A, the blade 51 moves powder deposited on the temporary depot 61b in the X direction, whereby the powder material falls into the space provided above the modeling stage 62 for thin-layer formation and a thin powder layer 92 of uniform thickness is formed. At this time, the lower tip of the blade 51 moves along the top surface of the modeling mechanism 60. This ensures that a thin layer of powder material is formed in a predetermined thickness. An excess powder material falls through the opening 70a and is deposited in the recovery section 71.

After the formation of the powder layer 92, the blade 51 is moved upward to be separated from the top surface by the driver 53 and passes over the powder layer 92 to return to its initial position.

In step S7, the nozzle head 22 is moved in the XY plane as shown in FIG. 5b by driving the XY-directional driver 23 according to the shape and color data generated in step S2. By scanning only regions with shape data, driving time can be accelerated. With the movement of the nozzle head 22, colored binders are selectively ejected from the ejection nozzles 22a to 22d and thereby a body of bound powder material is generated. Here, unbound regions of the powder material (unbound powder) to which no binder has been applied are independent of each other.

In the application of binders to regions corresponding to the surface of the 3D object 91, the Y, M, C, and W binders are selectively ejected according to the color information derived from the object to be molded. From this, the surface of the 3D object 91 can be colored during the modeling process, i.e., color modeling becomes possible. As to regions of the 3D object 91 which require no coloring (i.e., color-free portions), on the other hand, the W binder that would not spoil the conditions of the colored regions is applied for modeling.

In order to ensure the strength of the 3D object by evenly distributing the binders adhering to the powder layer 92, it is preferable that the same amounts of binders are applied per unit area of the regions to be modeled. For example, the same amounts of binders can uniformly be applied per unit area by keeping constant the product obtained by multiplying the travel speed of the ejection nozzles 22a to 22d driven by the XY-directional driver 23 by the amounts of binders (e.g., the number of binder droplets) which are ejected from those ejection nozzles 22a to 22d per unit time.

After the completion of the binder ejection, the operation to eject binders is terminated and the nozzle head 22 returns to the initial position by the action of the XY-directional driver 23.

Alternatively, a process of drying the binders may be inserted after the process of binder ejection. For example, a process of lighting the powder layer 92 from above with an infrared lamp or the like may be performed. This accelerates the drying of the binders adhering to the powder layer 92. Such a drying process, however, is unnecessary when using binders of the type that can be quickly hardened in air drying.

At the completion of the modeling of a single layer, the process proceeds to step S8 wherein the drive controller 12 determines whether or not all processing as many as the number of layers given in step S3 is completed. That is, whether the modeling of the 3D object 91 is completed or not is determined. If the answer to step S8 is NO, the processing from step S4 is repeated, while if the answer is YES, the process proceeds to step S9.

When the process returns to step S4, another operation is performed to form a new (N+1)th layer of bound powder material on the N-th layer. That is, the operation as shown in FIGS. 5A and 5B is repeated as many times as the number of layers to be formed. Through the repeated operation, a colored body of bound powder is sequentially formed in layers on the modeling stage 62 and consequently a final 3D object 91 is generated on the modeling stage 62. The process then proceeds to step S9 (the answer to step S8 is YES).

Step S9 is automatic conveyance of the 3D object 91 to the powder removal section 70 for removal of unbound powder.

First, the drive controller 12 gives a descent command to the driver 64 for the Z-directional moving section 63, thereby as shown in FIG. 5C to lower the modeling stage 62 to a position where the carrier mechanism 65 can push out the modeling stage 62 for conveyance.

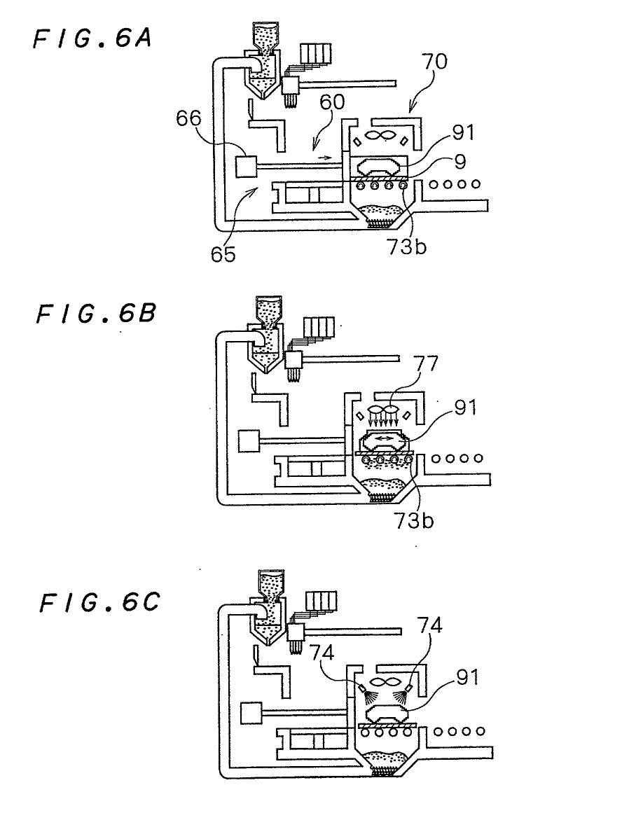

The drive controller 12 then gives drive commands to the carrier driver 66 for the carrier mechanism 65 and to the driver 73a for the carrier rollers 73b, thereby as shown in FIG. 6A to carry the mesh tray 9 and the 3D object 91 from the modeling mechanism 60 to the powder removal section 70.

In step S10, unbound powder adhering to the 3D object 91 is removed in the powder removal section 70. As shown in FIG. 6B, the air blower 77 is rotatably driven and the driver 73a effects reciprocating rotational movements of the carrier rollers 73b at any angle within the prescribed range, thereby to give horizontal vibrations to the mesh tray 9 and the 3D object 91 thereon. This removes the unbound powder material adhering to the 3D object 91. Consequently, only the 3D object 91 is placed on the mesh tray 9.

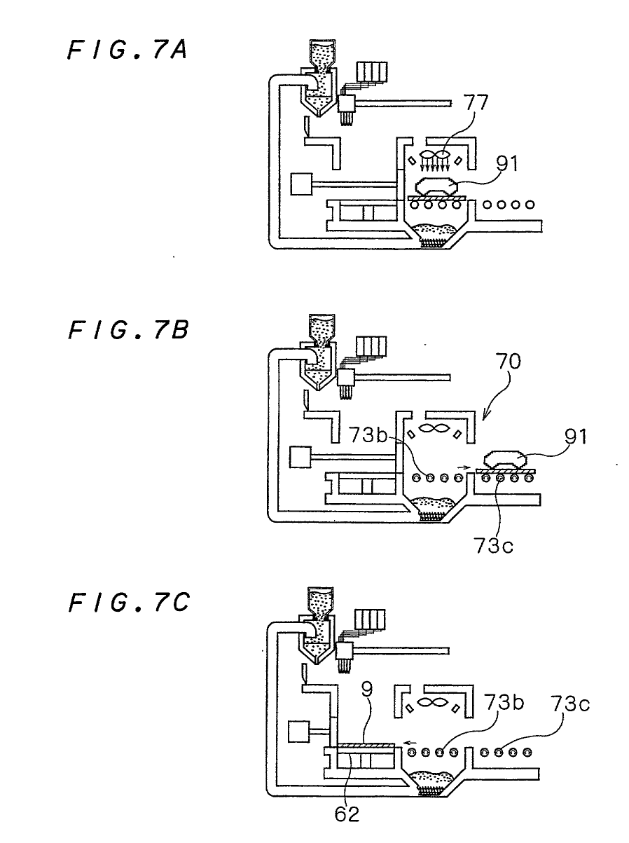

In step S11, post-processing is performed on the 3D object 91 after the unbound power material was removed therefrom. This is, more specifically, a process of improving the binding strength of the 3D object 91. As shown in FIG. 6C, the spray nozzle 74 sprays a predetermined curing material toward the 3D object 91 to impregnate the 3D object 91 with the curing material. Thereafter, the air blower 77 operates as shown in FIG. 7A to dry the curing material on the 3D object 91. This results in the improvement in the binding strength of the 3D object 91.

The process then proceeds to step S12 wherein the 3D object 91 is taken out. As shown in FIG. 7B, the drive controller 12 give a drive command to the driver 73a to rotatably drive the carrier rollers 73b and 73c in a predetermined direction, thereby to carry the 3D object 91 to the outside of the powder removal section 70. As a result, users can take out the 3D object 91 on the carrier rollers 73c.

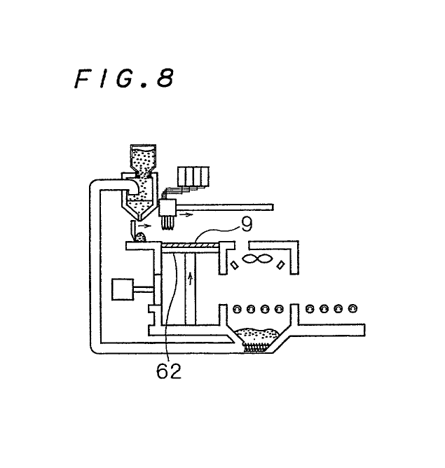

Then, as shown in FIG. 7C, the carrier rollers 73b and 73c are rotatably driven to return the mesh tray 9 onto the modeling stage 62. Following this, the modeling stage 62 is lifted to a position for fabrication of a next 3D object as shown in FIG. 8.

This completes the sequential operation of the 3D modeling apparatus 100 according to this preferred embodiment. Since the aforementioned 3D modeling apparatus 100 is configured to automatically remove the unbound powder material adhering to the 3D object 91, users can take out the 3D object 91 without scattering the powder material around the apparatus. Besides, the post-processing for improvement in the binding strength of the 3D object 91 is automated, which avoids the necessity of post-processing by users' manual operation after the 3D object is taken out.

The 3D modeling apparatus 100 is also configured to be able to carry the 3D object 91 automatically from the modeling mechanism 60 for modeling of the 3D object 91 to the powder removal section for removal of unbound powder material. This allows users to save time and manpower. Since the powder removal section 70 is located to the side of the modeling mechanism 60, the carrier mechanism 65 for automatic conveyance can come in a relatively simple configuration such as an extruding carrier mechanism.

In the 3D modeling apparatus of this preferred embodiment, the reservoir placement section 43 is provided on the upper side of the powder supply section 40 in order not to scatter a powder material as a material for modeling around the apparatus when replenishing the apparatus with the powder material. Also, the replaceable powder material reservoir 30 is mounted in the reservoir placement section 43 so that the lid of the reservoir 30 can be opened. Thus, the 3D modeling apparatus 100 can be replenished with the powder material without scattering of the powder material to the outside. In replacement of the powder material reservoir 30, the lid of the reservoir 30 is in the closed position; therefore, users can add the powder material without dirtying their hands or clothes.

The 3D modeling apparatus 100 is also configured such that the members for containing various materials such as a power material, binders, and a curing material are located above the level of the modeling mechanism 60 (cf. FIG. 1). This reduces an installation area of the whole apparatus and achieves ease of maintenance by users such as replacement of various materials, as compared to the conventional apparatuses wherein such members for various materials are located to the side of the modeling mechanism 60.

Further, since the 3D modeling apparatus 100 of this preferred embodiment is configured such that the 3D object 91 is located in the same position for removal of unbound powder and for post-processing, the installation area of the 3D modeling apparatus 100 can be reduced to a minimum. Also, the removal of unbound powder and the post-processing can be performed in the sequential operation, which improves the efficiency of processing.

Furthermore, the 3D modeling apparatus 100 of this preferred embodiment is configured such that the unbound powder material removed in the powder removal section 70 can be recovered in the recovery section 71 and the recovered powder material can be resupplied to the powder supply section 40 by the powder recovery mechanism 80. That is, the configuration permits automatic reuse of the unbound powder material. This avoids the necessity of users carrying out the task for reuse of unbound powder.

<2. Second Preferred Embodiment>

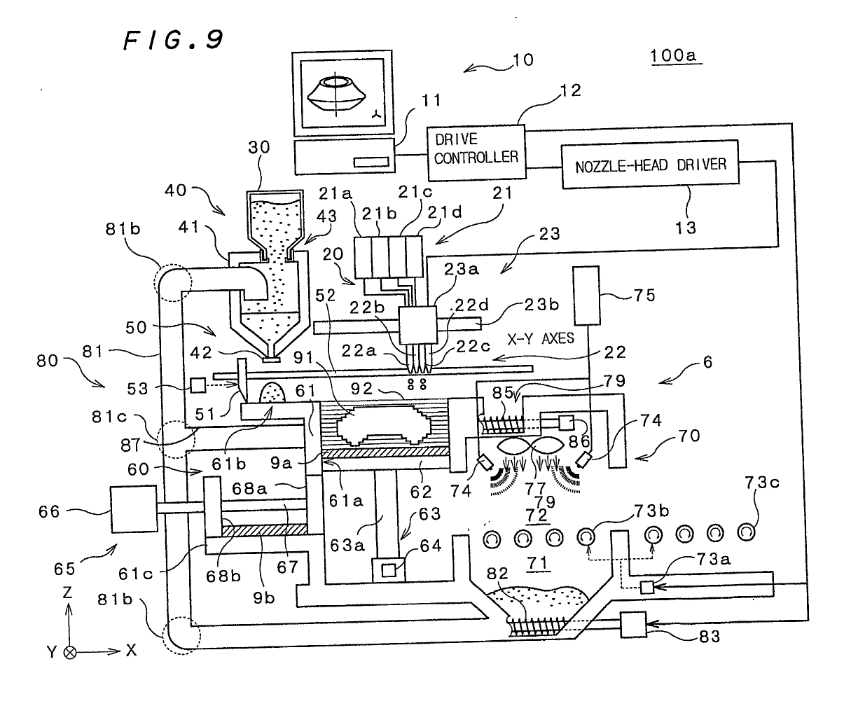

Next, a second preferred embodiment according to the present invention will be set forth. FIG. 9 is a schematic diagram of a 3D modeling apparatus 100a according to the second preferred embodiment. Like or corresponding parts to those described in the first preferred embodiment are denoted by the same reference numerals/characters and herein a detailed description thereof will be omitted.

The 3D modeling apparatus 100a of this preferred embodiment differs from the 3D modeling apparatus 100 of the first preferred embodiment in that it uses two mesh trays 9a and 9b and it comprises a carrier mechanism for recovering and carrying an excess powder material when the blade 51 spreads the powder material.

The carrier mechanism 65 in the 3D modeling apparatus 100a comprises the carrier driver 66, the extension member 67, and extruding members 68a and 68b. The extruding members 68a and 68b are coupled to the extension member 67, providing space enough to set the mesh tray 9b therebetween. The main body 61 of the modeling mechanism 60 is provided with a mounting stage 61c to place the mesh tray 9b. In the initial position, the extruding member 68a is held in a standby position to serve as a sidewall of the main body 61.

When the carrier mechanism 65 carriers the 3D object 91 generated on the modeling stage 62 and the mesh tray 9a to the powder removal section 70, the extruding member 68a extrudes the mesh tray 9a on the modeling stage 62 into the treatment chamber 72 in the powder removal section 70. At this time, the extruding member 68b extrudes the mesh tray 9b placed on the mounting stage 61c onto the modeling stage 62.

After the completion of the above extruding operation, the modeling stage 62 is lowered by an amount corresponding to the thickness of the mesh tray 9b and the extension member 67 in the carrier mechanism 65 is contracted so that the extruding member 68a is brought back to the initial position.

As a result, the 3D modeling apparatus 100a can perform modeling of another 3D object on the mesh tray 9b in the modeling mechanism 60 while at the same time, performing removal of unbound powder and post-processing of the 3D object 91 placed on the mesh tray 9a in the powder removal section 70.

The 3D modeling apparatus 100a is also configured such that when the blade 51 spreads the powder material along the X direction, an excess powder material is deposited in a recovery section 79 provided in the upper part of the powder removal section 70. By providing the recovery section 79 separately from the recovery section 71 in the powder removal section 70, it becomes possible to perform thin-layer formation of powder material even during removal of unbound powder in the powder removal section 70, for example.

A powder carrier screw 85 is provided at the bottom of the recovery section 79. This screw 85 constitutes part of the powder recovery mechanism 80 for carrying an excess powder material, which is recovered after formation of each powder layer 92, to the powder supply section 40.

The powder carrier screw 85 is located within a powder carrier conduit 87, running from the bottom of the recovery section 79 to a position near a connection 81c between the powder carrier conduits 81 and 87. One end of the powder carrier screw 85 is coupled to a rotation axis of a driver 86 which is constituted by a motor or the like, so that the powder carrier screw 85 is rotated in a predetermined direction by the driver 86.

By the action of the driver 86 and the powder carrier screw 85, the powder material deposited in the recovery section 79 is carried from the bottom of the recovery section 79 through the powder carrier conduit 87 to the connection 81c. From the connection 81c, the powder material is carried to the powder supply section 40 by the action of the powder carrier screw 82 which runs from the powder removal section 70 to the powder supply section 40 within the powder carrier conduit 81.

The other components of the 3D modeling apparatus 100a are identical to those described in the first preferred embodiment.

Next, actual operations of the above-configured 3D modeling apparatus 100a for fabrication of a 3D object will be set forth.

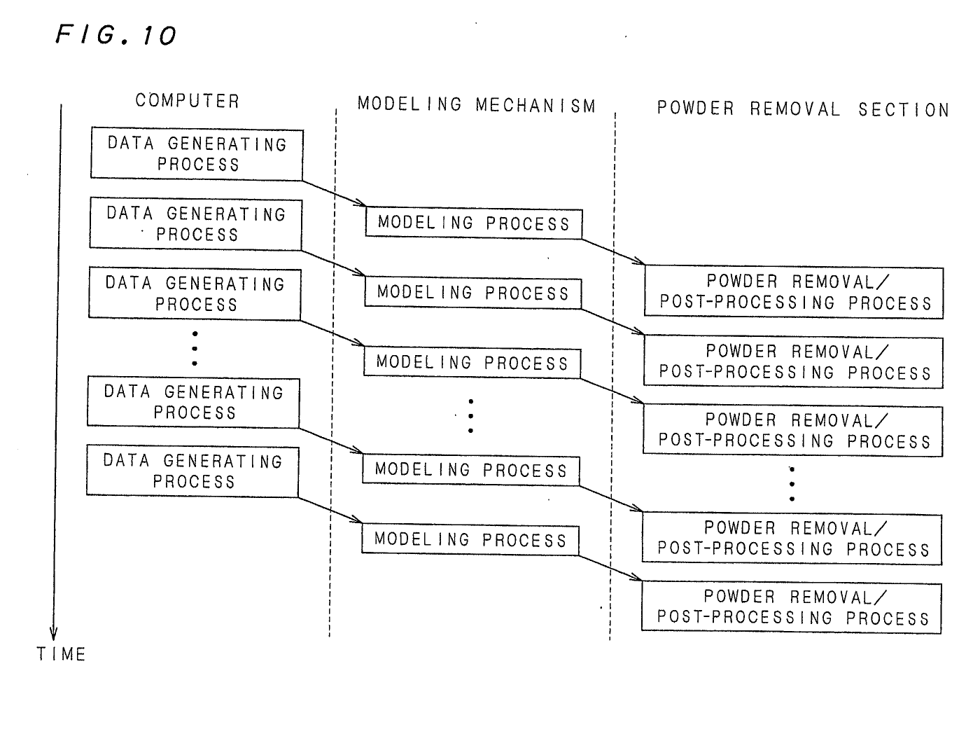

FIG. 10 is a schematic diagram showing the operating procedure of the 3D modeling apparatus 100a. As shown in FIG. 10, the computer 11 performs a data generating process for 3D modeling. This data generating process is equivalent to the steps S1 to S3 in the flow chart of FIG. 4 described in the first preferred embodiment.

After the completion of the data generating process by the computer 11, the modeling mechanism 60 performs a modeling process. The modeling process is a process of repeating the processing of steps S4 to S8 in the flow chart of FIG. 4. In this process, the formation of a powder layer 92 on the modeling stage 62 and the binder ejection are performed for each layer to form a body of bound powder material in sequence, thereby to generate a final 3D object 91.

After the completion of the modeling process by the modeling mechanism 60, a powder removal process and a post-processing process are performed in the powder removal section 70. The powder removing process and the post-processing process are equivalent to the steps S9 to S12 in the flow chart of FIG. 4. In those processes, unbound powder adhering to the 3D object 91 is removed while post-processing is performed to increase the binding strength.

The 3D modeling apparatus 100a, as previously described, comprises the two mesh trays 9a and 9b, one of which is located in the modeling mechanism 60 for use in 3D modeling and the other of which is used for powder removal and post-processing of the previously-generated 3D object 91. The apparatus can thus, as shown in FIG. 10, concurrently perform the modeling process in the modeling mechanism 60 and the powder removal and post-processing processes in the powder removal section 70. More specifically, the modeling of a 3D object and the removal of unbound powder and post-processing of the previously-generated 3D object can be performed simultaneously.

In the 3D modeling apparatus 100a of this preferred embodiment, the modeling mechanism 60 can continuously perform 3D modeling without waiting for the completion of the powder removal and the post-processing in the powder removal section 70. This enhances throughput of 3D modeling.

The 3D modeling apparatus 100a of this preferred embodiment can also perform the data generating process in the computer 11 simultaneously with the above processes as shown in FIG. 10 and therefore can perform 3D modeling with efficiency.

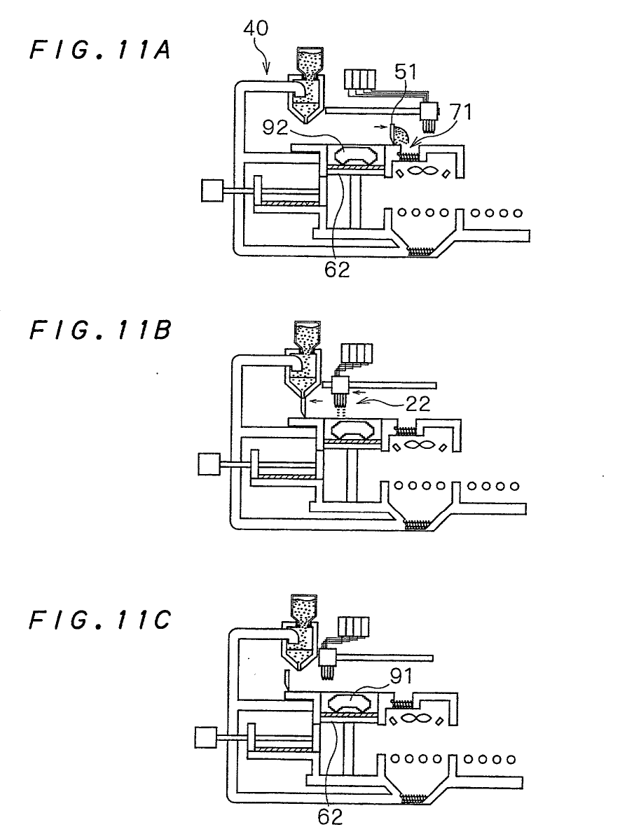

Next, the operation of each section will be set forth. FIGS. 11A to 11C, 12A to 12C, 13A to 13C, 14A and 14B are schematic diagrams illustrating the above operations.

First in the modeling process, a powder material is spread over the modeling stage 62 to form a single thin layer of powder material. More specifically, as shown in FIG. 11A, powder deposited on the powder temporary depot 61b is moved by the blade 51 in the X direction and finds its way into the space provided above the modeling stage 62 for thin-layer formation, whereby a thin powder layer 92 of uniform thickness is formed. An excess powder material is deposited in the recovery section 71 and then carried to the powder supply section 40.

The drive controller 12 drives the XY-directional driver 23 according to the shape and color data to move the nozzle head 22 in the XY plane as shown in FIG. 11B. By scanning only regions with shape data, driving time can be accelerated. With the movement of the nozzle head 22, colored binders are selectively ejected from the ejection nozzles 22a to 22d and a body of bound powder material is generated.

By repeating the thin-layer formation of powder material and the binder ejection as shown in FIGS. 11A and 11B, a 3D object 91 is produced on the modeling stage 62 as shown in FIG. 11C.

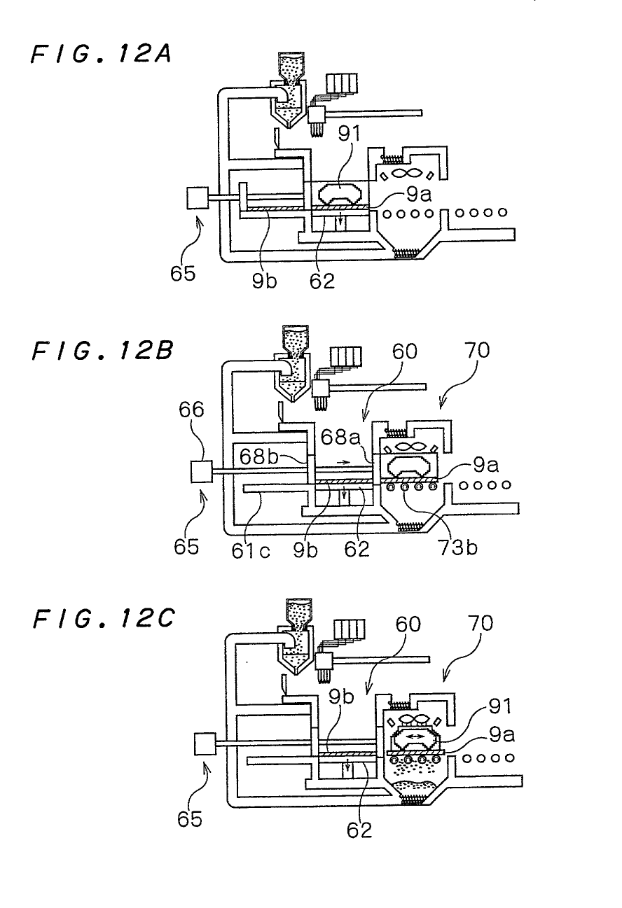

The 3D object 91 is then automatically carried to the powder removal section 70 to remove unbound powder therefrom. The drive controller 12 gives a descent command to the driver 64 for the Z-directional moving section 63, thereby as shown in FIG. 12A to lower the mesh tray 9a on the modeling stage 62 to a position where the carrier mechanism 65 can push out the mesh tray 9a for conveyance. The drive controller 12 then gives drive commands to the carrier driver 66 for the carrier mechanism 65 and to the driver 73a for the carrier rollers 73b, thereby as shown in FIG. 12B to carry the mesh tray 9a and the 3D object 91 from the modeling mechanism 60 to the powder removal section 70. At this time, the mesh tray 9a is pushed toward the powder removal section 70 by the extruding member 68a, while the mesh tray 9b placed on the mounting stage 61c is carried by the extruding member 68b onto the modeling stage 62 in the modeling mechanism 60.

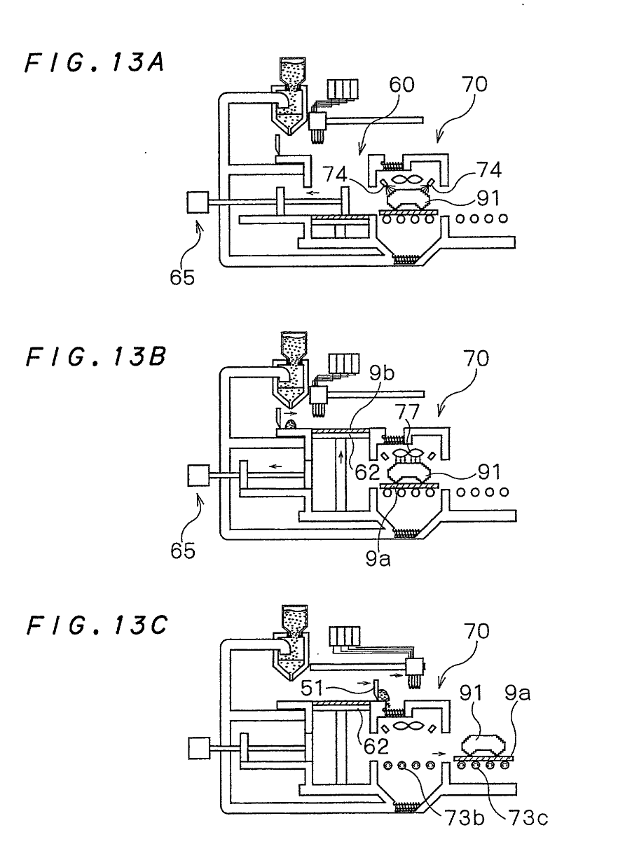

Following this, as shown in FIG. 12C, the powder removal section 70 starts the removal of unbound powder from the 3D object 91 on the mesh tray 9a. Also, the modeling stage 62 is lowered by an amount corresponding to the thickness of the mesh tray 9b in order to enable the return of the carrier mechanism 65 to the original position. Then, as shown in FIG. 13A, the carrier mechanism 65 is returned back to the original position. When the powder removal in the powder removal section 70 is completed, the spray nozzle 74 sprays a curing material for post-processing of the 3D object 91.

As shown in FIG. 13B, when the carrier mechanism 65 returns to its original position, the modeling stage 62 with the mesh tray 9b placed thereon ascends to a position for next 3D modeling. This allows the modeling mechanism 60 to start the fabrication of a next 3D object 91. In the powder removal section 70, when the impregnation of the 3D object 91 on the mesh tray 9a with the curing material is completed, the air blower 77 sends air to dry the curing material.

As of this point in time, the 3D modeling by the modeling mechanism 60 and the powder removal and post-processing by the powder removal section 70 are performed simultaneously. Thus, as shown in FIG. 13C, the modeling mechanism 60 can continuously start next fabrication of a 3D object without waiting for the completion of the processing in the powder removal section 70. When the post-processing is completed in the powder removal section 70, the carrier rollers 73b and 73c are driven to carry the mesh tray 9a and the 3D object 91 to the outside of the powder removal section 70.

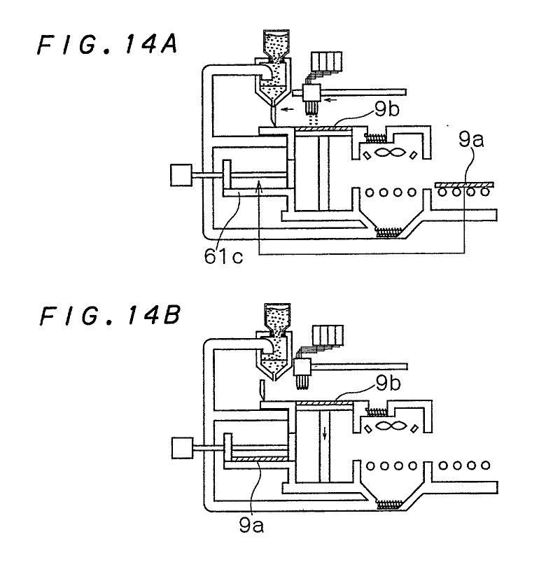

After users take out the 3D object 91, the mesh tray 9a on the carrier rollers 73c is carried onto the mounting stage 61c as shown in FIG. 14A either by a tray reset unit not shown or with user intervention. Thereby the mesh tray 9a is brought onto the mounting stage 61c as shown in FIG. 14B, by which the 3D modeling apparatus 100a is ready for next 3D modeling. During this operation, the modeling mechanism 60 continues 3D modeling on the mesh tray 9b.

As above described, the 3D modeling apparatus 100a of this preferred embodiment is configured to exchange the mesh trays 9a and 9b to be placed on the modeling stage 62 when carrying the 3D object 91 generated on the modeling stage 62 to the powder removal section 70. The apparatus 100a can thus simultaneously perform 3D modeling in the modeling mechanism 60 and powder removal and post-processing in the powder removal section 70.

<3. Third Preferred Embodiment>

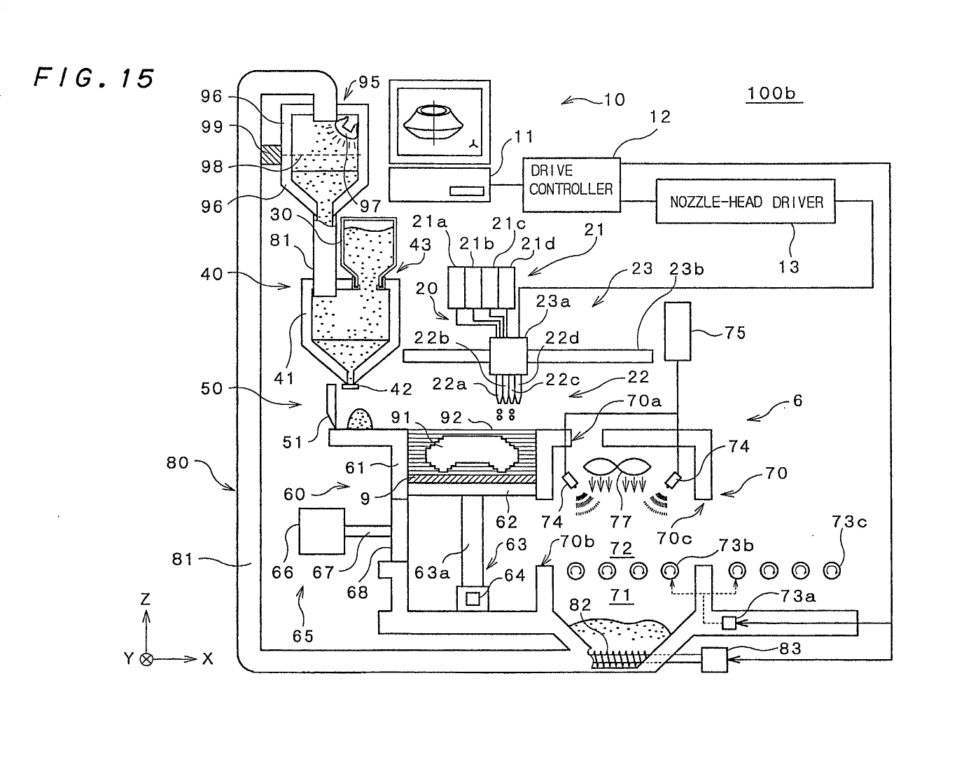

Next, a third preferred embodiment according to the present invention will be set forth. FIG. 15 is a schematic diagram of a 3D modeling apparatus 100b according to the third preferred embodiment of the present invention. In FIG. 15, like or corresponding parts to those described in the above preferred embodiments are denoted by the same reference numerals/characters and herein a detailed description thereof will be omitted.

In each of the above preferred embodiments, there is a possibility that the binders, the curing material, or the like can adhere to the recovered powder material after use. This incurs a second possibility that the powder supply section 40 may contain a recovered powder material that has been bound into great lumps. It can also be considered that particles of a moist powder material due to moist air can be bound together. The supply of such a powder material from the powder supply section 40 will produce phenomena such as fluctuation in the supply of powder material and lack of uniformity of the powder layer 92, resulting in deterioration in modeling accuracy.

For that reason, this preferred embodiment provides an example of a configuration having a mechanism for dividing such lumps of powder material held in the powder supply section 40 into a finely isolated powder.

As shown in FIG. 15, the 3D modeling apparatus 100b of this preferred embodiment comprises a powder processor 95 as part of the powder recovery mechanism 80. The powder processor 95 is configured to dry the binders, the curing material, or the like included in the recovered powder material or to remove moisture from the powder material, in order not to resupply a powder material which was bound to a size larger than a predetermined size to the powder supply section 40.

More specifically, the powder processor 95 comprises a powder reservoir 96, a dryer 97, a mesh filter 98, and a vibration generator 99.

The powder reservoir 96 serves as a treatment chamber for drying the above powder material, for example. The recovered powder material transmitted through the powder carrier conduit 81 is supplied from the upper part of the powder reservoir 96. The dryer 97 and the mesh filter 98 are located within the powder reservoir 96. The dryer 97 is provided with a heat source such as an infrared lamp. The radiation of heat from the heat source dries a powder material with the binders or the curing material adhering thereto or a moist powder material due to moist air.

The mesh filter 98 is a filter with a number of meshes of a predetermined size. When particles of the powder material dried by the dryer 97 are of a mesh size or smaller, they fall through the meshes toward the lower side of the powder reservoir 96.

The vibration generator 99 is provided to make the function of the mesh filter 98 to sift the powder material more effective. The vibration generator 99 is configured to vibrate the mesh filter 98 in the XY plane. By the action of the vibration generator 99, the mesh filter 98 vibrates and thereby particles of the powder material of a mesh size or smaller are effectively led to the lower part of the powder reservoir 96.

The mesh filter 98 can remove a large powder material which has been bound with the binders or the curing material, thereby preventing conveyance of such a large powder material to the powder supply section 40.

This allows the reuse of the powder material supplied from the powder supply section 40 at the time of modeling and allows constant use of a predetermined-sized or smaller powder material in 3D modeling, thereby maintaining a constant supply of powder material and uniformity of the powder layers 92. Accordingly, there will be no degradation in the accuracy of 3D modeling The aforementioned powder processor 95 with the dryer 97, the mesh filter 98, and the like can be located in a position either around an inlet or an outlet of the powder carrier path in the powder carrier conduit 81.

<4. Modifications>

While the preferred embodiments of the present invention have been described hereinabove, it is to be understood that the present invention is not limited to those described in the above preferred embodiments.

For example, while the above preferred embodiments provide examples of a configuration wherein a powder material supplied from the powder supply section 40 is spread by the blade 51, the present invention is not limited thereto but the powder material may be spread by a rotational roller, for example.

Further, while the above preferred embodiments provide examples of a configuration that allows coloring of a 3D object, it goes without saying that the features of the present invention are also adaptable to other 3D modeling apparatuses that make a reproduction of only the shape of a 3D object without coloring.

While the invention has been shown and described in detail, the foregoing description is in all aspects illustrative and not restrictive. It is therefore understood that numerous modifications and variations can be devised without departing from the scope of the invention.

What is claimed is:

1. A three-dimensional modeling apparatus for fabricating a three-dimensional object by binding a powder material with a binding material, comprising:
a modeling section for forming a body of bound powder material in sequence by applying said binding material to said powder material to bind said powder material, thereby to generate said three-dimensional object;
a placement section for mounting of a powder material reservoir containing said powder material; and
a powder supply section for supplying said powder material in said powder material reservoir mounted in said placement section to said modeling section.

2. The apparatus according to claim 1, wherein
said powder supply section is located above the level of said modeling section.

3. The apparatus according to claim 1, wherein
said modeling section includes a supply section for supplying a binding material from above onto said powder material supplied from said powder supply section to represent a predetermined shape.

4. A three-dimensional modeling apparatus for fabricating a three-dimensional object by binding a powder material with a binding material, comprising:
a supply section for supplying said powder material;
a modeling section for forming a body of bound powder material in sequence by selectively applying said binding material to said powder material supplied from said supply section to bind said powder material, thereby to generate said three-dimensional object; and
a removal section for removing an unbound powder material from said three-dimensional object generated in said modeling section, said unbound powder material being said powder material supplied from said supply section but not receiving said binding material.

5. The apparatus according to claim 4, further comprising:
a carrier mechanism for carrying said three-dimensional object generated in said modeling section to a position for removal of said unbound powder material in said removal section.

6. The apparatus according to claim 4, further comprising:
a post-processing section for performing post-processing on said three-dimensional object after said unbound powder material is removed in said removal section.

7. The apparatus according to claim 6, wherein
said post-processing section includes a curing material supply section for applying a curing material to said three-dimensional object, and
said post-processing includes a process of impregnating said three-dimensional object with said curing material.

8. The apparatus according to claim 7, wherein
said post-processing section further includes an air blower for sending air to said three-dimensional object, and
said post-processing further includes a process of drying said curing material used to impregnate said three-dimensional object therewith, by air from said air blower.

9. The apparatus according to claim 6, wherein
said three-dimensional object is located in the same position for removal of said unbound powder material in said removal section and for said post-processing in said post-processing section.

10. The apparatus according to claim 5, wherein
said three-dimensional object carried by said carrier mechanism is placed on a mesh tray, and
said carrier mechanism carries said three-dimensional object by carrying said mesh tray.

11. A three-dimensional modeling apparatus for fabricating a three-dimensional object by binding a powder material with a binding material, comprising:
a supply section for supplying said powder material;
a modeling section for repeating a process of applying said binding material to said powder material supplied from said supply section to bind said powder material in order to represent each section of said three-dimensional object, thereby to generate said three-dimensional object; and
a feed section for recovering and returning an unbound powder material to said supply section, said unbound powder material being said powder material supplied from said supply section but not receiving said binding material.

12. The apparatus according to claim 11, wherein
said feed section includes a drying mechanism for drying said powder material recovered.

13. The apparatus according to claim 11, wherein
said feed section includes a filter for extracting only said powder material of not more than a predetermined size.

14. A three-dimensional modeling method for fabricating a three-dimensional object by binding a powder material with a binding material,
said method using a predetermined apparatus to avoid a user's contact with said powder material,
said method comprising the steps of:
(a) placing a mesh tray for use in passing said powder material into a bottom of a box-like modeling space, in such a manner as to support a whole bottom surface of said mesh tray;
(b) repeating a process of supplying said powder material flatly in a predetermined thickness in said modeling space and a process of selectively applying said binding material onto said powder material supplied to bind said powder material in order to represent a predetermined shape, thereby to generate on said mesh tray said three-dimensional object bound with said binding material with an unbound powder material remaining therewith;
(c) supporting part of said mesh tray above a predetermined space for collecting said unbound powder material; and
(d) dropping said unbound powder material into said predetermined space to obtain said three-dimensional object.

15. The method according to claim 14, wherein
a first position to support said mesh tray in said step (a) and a second position to support said mesh tray in said step (c) are different,
said method further comprising, between said steps (b) and (c), the step of:
moving said mesh tray from said first position to said second position when said mesh tray is loaded with said three-dimensional object bound with said binding material with an unbound powder material remaining therewith.

16. The method according to claim 15, further comprising the step of:
after said unbound powder material is dropped off, performing predetermined post-processing on said three-dimensional object at said second position.

17. The method according to claim 16, further comprising the step of:
generating another three-dimensional object at said first position while dropping said unbound powder material from said three-dimensional object at said second position, or during said post-processing.
